(19) United States
(12) Patent Application Publication
(10) Pub. No.: US 2014/0074677 A1
(43) Pub. Date: Mar. 13, 2014

(54) Financial News Generation System

(71) Applicant: Ted Dixon, Vancouver (CA)

(72) Inventor: Ted Dixon, Vancouver (CA)

(73) Assignee: Ink Research Corp., Vancouver (CA)

(21) Appl. No.: 14/004,339

(22) PCT Filed: Mar. 12, 2012
(86) PCT No.: PCT/CA2012/000231

§ 371 Date: Nov. 21, 2013

Related U.S. Application Data
(60) Provisional application No. 61/451,308, filed on Mar. 10, 2011.

(51) Int. Cl. G06Q 40/00

(52) U.S. Cl. CPC G06Q 40/00
USPC 705/35

(57) ABSTRACT

A computer process generates news stories and related graphic images by compiling and reformulating financial data in relation to insider ownership. The news stories and images may be published as readable articles in print publications such as magazines, newsletters or newspapers, presented as web pages, as text or images delivered by email, interne messaging or mobile messaging including text messaging, or as text or images delivered by any proprietary distribution network including electronic net works.

### FIELD OF THE INVENTION

The present invention relates to information management systems, and particularly relates to a method and apparatus for compilation and reformulation of insider ownership to generate financial news stories.

### DESCRIPTION OF THE INVENTION

Increasingly, companies and individuals rely on accurate, timely, accessible financial information in order to make business decisions. At present, there is a wide variety of information sources of varying quality. It is a challenge to access and review useful information from the ever growing volume of financial news stories published in a variety of media.

The present invention provides a method of automated compilation and reformulation of data to generate relevant information to allow more effective knowledge transfer.

The system of the present invention comprises a computer system which is able to extract from information sources available from capital market regulators information in relation to insider ownership levels and changes in insider ownership levels. This insider ownership data is processed using a defined set of calculations. These calculations are used to generate insider characteristics. These characteristics can be used on their own or used in joint calculations with other financial market information (including but not limited to unique identifiers such as Bloomberg security codes, price and volume exchange data, financial statement valuation factors such as debt to equity ratios, derived financial ratios such as price to book value ratios and technical indicators such as the spot price divergence from an historical average) to be generate data sets ordered by but not limited to security type, stock symbol, company name, industry name, sector name, market name, or unique company, stock, industry, sector or market identifier, based on expected returns, either positive and negative. Such ranked information is further processed by computer-based algorithms to generate summaries of data that include text, words, sentences, paragraphs and graphical components. Such data summaries may be translated into multiple languages by computer translation modules. These summaries are referred to herein as “news stories”. These news stories may or may not be edited or revised manually. These summaries are referred to herein as “news stories”.

According to one embodiment, there is provided a computer implemented process that accesses a plurality of data sources to generate a textual output in the form of one or more easily understood sentences in any language. The process may be operated by one or more programmed computer processors. The process accesses one or more databases which store and retrieve information from the plurality of data sources. In one embodiment, among the plurality of data sources will be at least one data source which contains data provided by, licensed from, or mandated by a securities regulator or government body which collects information from company officers, directors, or significant shareholders who have ownership, control, or direction of more than 5% of any security class of an issuer of such securities which are available to the public.

The preferred operating environment for the present invention comprises a general-purpose computing device in the form of a personal computer linked via the Internet according to known methods to other general purpose computing devices.

The news stories generated by the system of the invention may be published as articles in print publications such as magazines, newsletters or newspapers, and related graphic images generated by one or more computers. The news stories may be presented as web pages, as text or images delivered by email, Unmet messaging or mobile messaging including text messaging, or as text or images delivered by any proprietary distribution network including electronic networks.

Further, the news stories may be presented as audio or video output generated from other news story formats by one or more computers. The news stories may also be transmitted to other media distribution services including web pages and various forms of social media.

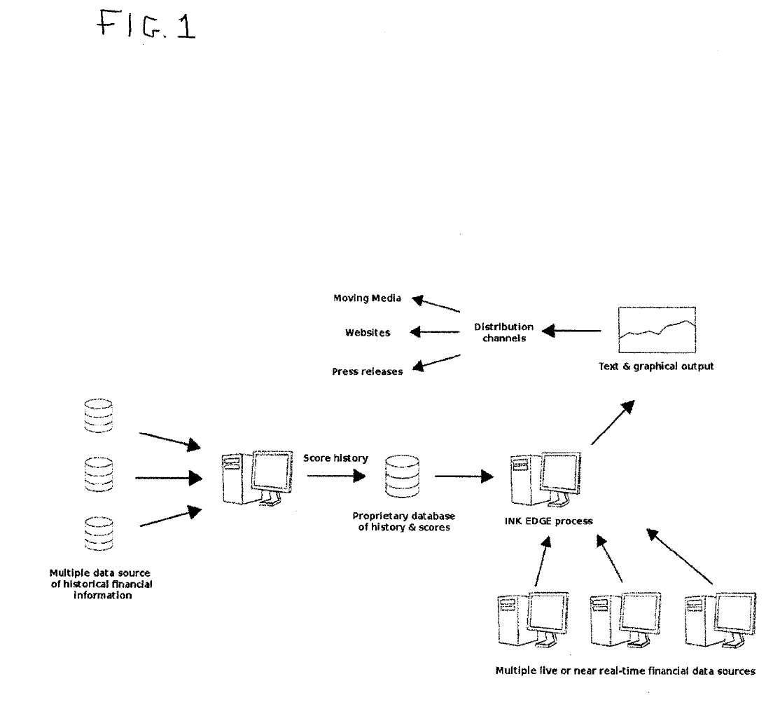

As shown in FIG. 1, the INK EDGE process of the present invention mines multiple data sources for historical financial information, assigns scores to these histories and stores these in a proprietary database. These data are processed with data from multiple live or near real-time financial data sources, to generate text and graphical output which may be distributed through a variety of end-user media, including moving media, websites and press releases.

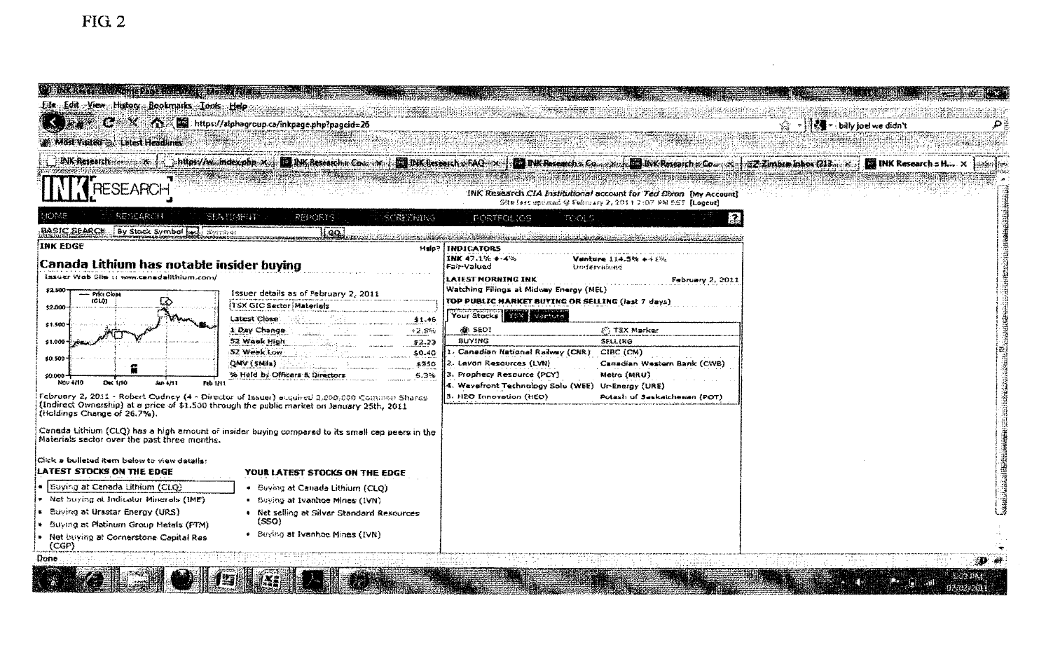

As depicted in FIG. 2, a news story derived from one or more data sources may be generated and published on a webpage. In the figure, the story entitled “Canada Lithium has notable insider buying” is presented as generated by the system of the invention, rather than as written by a human author. The web page version of the invention is represented in text and graphics. In the embodiment presented, one news story may be featured in a main window of a web page, while other generated news stories may be presented as links below the main window. Selection of each link will bring the news story into the main window to replace the “Canada Lithium” story.

In a preferred embodiment, the invention may be used to compile and reformulate financial data from insider ownership information. Many other applications are also possible using other forms of data inputs, including non-financial data.

In the figures, one embodiment of the invention is illustrated by way of example. It is to be expressly understood that the description and drawings are only for the purpose of illustration and as an aid to understanding, and are not intended as a definition of the limits of the invention. It will be appreciated by those skilled in the art that other variations of the preferred embodiment may also be practiced without departing from the scope of the invention.

1. A method of generating news stories from financial data, comprising the steps of:
a. extracting insider financial data from selected financial data sources;
b. processing the extracted data using a defined set of calculations to generate insider characteristics;
c. using the insider characteristics to generate data sets based on expected financial returns;
d. processing the data to generate textual and graphical outputs translatable into readable news stories in a plurality of languages.

2. The method of claim 1, wherein at least one of the data sources contains data provided by a securities regulator or government body which collects information from company officers, directors, or significant shareholders.

3. A general-purpose computing device programmed to carry out the method of claim 1.

4. A general-purpose computing device programmed to carry out the method of claim 1 linked via the Internet to other general-purpose computing devices, wherein the output of the method of claim 1 is available to the computing devices via the Internet.
